(19) United States
(12) Patent Application Publication
(10) Pub. No.: US 2019/0364952 A1
(43) Pub. Date: Dec. 5, 2019

(54) FOOD PROCESSING SYSTEM AND ASSOCIATED METHOD

(71) Applicant: NESTEC S.A., Vevey (CH)

(72) Inventor: Jean-Marc Flick, Pomy (CH)

(21) Appl. No.: 16/462,299

(22) PCT Filed: Dec. 7, 2017
(86) PCT No.: PCT/EP2017/081866

§ 371 Date: May 20, 2019

(30) Foreign Application Priority Data
Dec. 14, 2016 (EP) 16203991.1

(51) Int. Cl. A23P 20/20; A23L 5/10; B33Y 10/00; B33Y 30/00

(52) U.S. Cl. CPC A23P 20/20; A23L 5/15; A23P 2020/253; B33Y 30/00; B33Y 10/00

(57) ABSTRACT

The invention relates to a food processing system (100) able to deposit and/or deliver food under a certain pattern and to heat and/or cook at least part of it, the deposition being done onto a deposition surface (103) by at least a deposition head (102) in one or a plurality of shapes and/or layers; the food processing system (100) further comprising cooking means, these cooking means comprising: —at least a laser source (110) of the diode type generating at least a laser beam (112) with a certain power and wavelength; —an optical system (120) designed to collimate and/or focalize and/or homogenize the laser beam; —a steering system (130) directing the laser beam from the optical system towards the food pattern deposited onto the surface (103), the steering system being able to cover a certain scanning area (111); such that the laser beam (112) is directed to at least part of the food pattern as it is deposited onto the deposition surface (103) or after it has been deposited so as to selectively heat and/or cook at least part of the deposited shapes and/or layers. The invention further relates to a method for preparing a foodstuff by using a food processing system (100) as the one described, the method comprising the following steps: —depositing onto the deposition area (103) a certain food pattern in one or a plurality of shapes and/or layers; —activating the laser simultaneously or successively to the deposition of the food pattern to heat and/or cook at least part of the deposited shapes and/or layers.

### FIELD OF THE INVENTION

The present invention is directed to a system for processing food and, in particular, to a system comprising cooking means to allow cooking part of the food processed. The invention further relates to a method associated to such system.

### BACKGROUND OF THE INVENTION

At present, processed food is becoming more and more widely used in the pursit of saving time and efforts. However, the perception of processed food that many people have is that it is not sufficiently healthy and is not adequate for each person's needs. Therefore, present trends of processed foods require that it is made more healthy and adapted to each individual's needs, that it is more convenient and the least number of processing operations is required from the consumer and, even more, that the waste is minimised so only the quantity of food to be consumed is ideally prepared.

Currently, known processed foods are bought totally raw or partially cooked and need to be cooked at home by using traditional cooking devices, such as frying devices, microwaves, ovens or the like. The drawbacks of these standard solutions are that, on one side, the food bought is not adapted to the consumer's needs and, on the other side, the consumer has to still process and cook the food at home, so the complete process requires time, further devices and the result is not always satisfactory, which makes the whole process not convenient.

A possibility for preparing tailored food adapted to each individual's needs would be to directly configure, departing from raw ingredients, the food that will be further cooked into a ready-to-eat meal. A food processing system based on layer deposition and layer cooking by layers belonging to the applicant was already filed under EP 15166200.4. The aim of the present application is to disclose the heating and/or cooking means used in such a system in order to prepare the food product.

As it will be further described in detail, the present invention will heat and/or cook each of the layers deposited, one by one, using specific cooking profiles, so that the preparation of each one of the layers and therefore of the whole food product is made optimal, which is not the case at present in the known prior art.

### OBJECT AND SUMMARY OF THE INVENTION

According to a first aspect, the present invention relates to a food processing system able to deposit and/or deliver food under a certain pattern and to heat and/or cook at least part of it: deposition is done onto a deposition surface by at least a deposition head in one or a plurality of shapes and/or layers; the food processing system further comprises cooking means. The cooking means in the food processing system of the invention comprises: at least a laser source of the diode type generating at least a laser beam with a certain power and wavelength; an optical system designed to collimate and/or focalize and/or homogenize the laser beam; a steering system directing the laser beam from the optical system towards the food pattern deposited onto the surface, the steering system being able to cover a certain scanning area. In the food processing system of the invention, the laser beam is directed to at least part of the food pattern as it is deposited onto the deposition surface or after it has been deposited so as to selectively heat and/or cook at least part of the deposited shapes and/or layers.

Preferably, the steering system of the invention comprises at least two rotatable mirrors, such that the scanning area in the deposition surface is defined by the rotation of the mirrors, their respective angle and their distance to the deposition surface.

Typically, the steering system in the food processing system of the invention comprises a high speed mirror galvanometer set-up.

According to an embodiment of the invention, the mirrors are coated with a specific material to reflect the specific wavelength of the laser beam.

Typically, the food processing system of the invention comprises at least one steering system with at least one laser source per laser beam wavelength provided.

In the food processing system of the invention, the deposition surface and the deposition head are typically moveable relative to each other in order to deposit a food pattern in one or a plurality of shapes and/or layers. The deposition surface and the cooking means are preferably moveable relative to each other in order to selectively heat and/or cook at least part of the deposited shapes and/or layers. Typically, the steering system is designed to direct the laser beam perpendicularly to the deposition area.

In the food processing system of the invention, the laser power and/or wavelength and/or driving mode (continuous or pulsed) and/or scanning velocity is typically adapted to the nature of the food pattern deposited, this being measured at different instant times along the heating and/or cooking process.

Preferably, the driving mode (continuous or pulsed) of the laser beam in the system of the invention changes as a function of the evolution of the food heated and/or cooked.

Typically, the optical system further comprises a light collimator and/or a beam expander. The optical system can further comprise a focal lens displaceable to be closer or farer from the laser source. Furthermore, the optical system can comprise an aperture to shape the laser beam before it is sent to the scanning system.

In the food processing system of the invention, the laser source, the optical system and the steering system are preferably located in separated and distinct chambers within the system.

The deposition surface is typically separated from the rest of the system by a window through which the laser beam penetrates, the window being made of a material adapted to the laser beam wavelength to provide maximum transmittance and minimum absorption.

Preferably, the laser source in the food processing system of the invention operates emitting a pulsed laser beam in order to penetrate in depth in the food pattern deposited to heat and/or cook it, such that the frequency and the length of the pulse defines the penetration rate in the food pattern deposited.

According to a second aspect, the invention relates to a method for preparing a foodstuff by using a food processing system as the one described; this method comprises the following steps: depositing onto the deposition area a certain food pattern in one or a plurality of shapes and/or layers; activating the laser simultaneously or successively to the deposition of the food pattern to heat and/or cook at least part of the deposited shapes and/or layers.

Preferably, in the method of the invention, the laser power and/or wavelength and/or driving mode (continuous or pulsed) and/or scanning velocity is adapted to the nature of the food pattern deposited, this being measured at different instant times along the heating and/or cooking process.

Furthermore, in the method of the invention, typically a pulsed laser beam is used to heat and/or cook the food pattern deposited, such that the frequency and the length of the pulse used are chosen according to the desired penetration rate in the food pattern deposited.

### BRIEF DESCRIPTION OF THE DRAWINGS

Further features, advantages and objects of the present invention will become apparent for a skilled person when reading the following detailed description of embodiments of the present invention, when taken in conjunction with the figures of the enclosed drawings.

FIG. 1 shows a general overview of a food processing system according to the present invention.

FIG. 2 shows the disposition of cooking means in a food processing system according to the invention, the cooking means comprising a laser source, an optical system and a steering system.

FIG. 3 shows the disposition of the laser beam and scanning area created by cooking means in a food processing system according to the invention as shown in FIG. 2.

FIGS. 4-5 show a food processing system according to the present invention comprising cooking means according to a first possible embodiment, the cooking means comprising one laser source.

FIGS. 6-8 show a food processing system according to the present invention comprising cooking means according to a second possible embodiment, the cooking means comprising two laser sources.

### DETAILED DESCRIPTION OF EXEMPLARY EMBODIMENTS

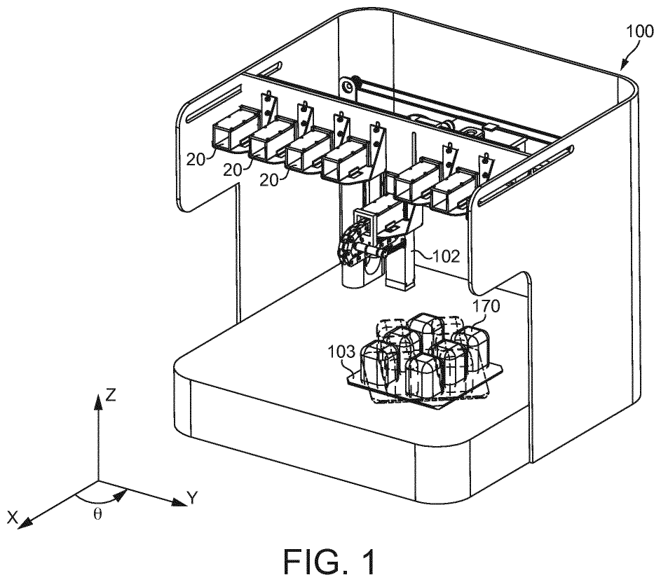

The food processing system 100 according to the present invention is represented in FIG. 1. It comprises one or a plurality of cartridges 20 comprising inside a dehydrated food product (dried or semi-dried product), typically a food powder. The powder coming from one of the containers 20 is sent to a deposition head 102 where it is reconstituted and/or structured and/or texturized before it is delivered onto a deposition surface 103. The processed food product is delivered through the deposition head 102 preferably in layers that will successively configure a food pattern 170, as schematically represented in FIG. 1.

For configuring the food patterns 170, the system 100 of the invention is configured in such a way that the deposition surface 103 and the deposition head 102 are moveable with respect to each other.

The food processing system 100 of the invention further comprises cooking means comprising a laser source 110, configured to heat and/or cook the layers deposited onto the deposition area 103, preferably layer by layer. The laser source in the cooking means is of the diode type, and it generates a laser beam with a certain power and wavelength.

The laser diode can be driven in two different modes, typically a continuous mode (also called CW, Continuous Wavelength) and a pulsed mode (called QCW, Quasi-Continuous Wavelength).

The absorption of the light emitted by the laser diode depends on several parameters. Tests show that, for the same light emitted at a certain wavelength, a darker food product (darker substrate) will absorb more light. The difference for the tested materials is significant for materials having a darker color. It can also be observed that the wavelength has an impact on the light transmission through the food material even with darker color: for materials having a white or transparent appearance, the lower the laser wavelength is, the better the light transmission.

Therefore and depending on the food fraction volume and on the food height, a cooking strategy will have to be specifically defined in order to obtain either a volume cooking or a surface cooking. This means that, above the wavelength, the colour of the food material is predominating factor for the light absorption. When the laser power is increased, the modification of the food structure will be achieved in a shorter time. Thus, depending on the nature of the food, it would be required to cook it smoothly in order to keep the advantage of the light penetration.

When changing the mode of the laser diodes, the pulsed mode is more efficient regarding the conversion of light into heat energy. Due to the food material phase change during the cooking, the light depth transmission and the material reflectivity change quite quickly. Therefore and in comparison to the standard cooking method which is mainly based on conduction, it is important to adapt the pulsed mode parameters, the level of power and the wavelength of the laser source to cook the food fraction or the food material in an optimal way. This also demonstrates that, for each type of food ingredient (and its mixes), it has to be cooked in a certain and specific way and with certain parameters, for an optimal result.

The advantage of a personalized food system is that all the raw food materials are already known by the system as they are held in individual containers so it is not required to implement a recognition system on prepared dishes as it would be for example the case in standard home ovens.

Most of the laser systems used in industry are designed to cut, weld, vaporize or make the ablation of non-organic materials. The laser is usually confined in a separate chamber and sometimes a few meters away from the working area where the laser would act on the material to be processed. Laser sources such as diodes usually require an additional optical system to homogenise, collimate and focus the laser beam. This is not required for gas tube or crystal based lasers which generate highly collimated beams due to the large cavity in which the laser is formed. This is not the case for laser based diodes which have a shorter cavity thus making the generated light more divergent.

Once the laser beam is emitted it requires to be directed towards the surface of the substrate to be processed and, depending on the nature of the operation to be performed, the laser beam will have to be moved or deviated at different angles. A simple optical mirror can be used to change the angle of the beam in one direction and a displaceable optical lens can be used in combination to move the beam in the XY direction.

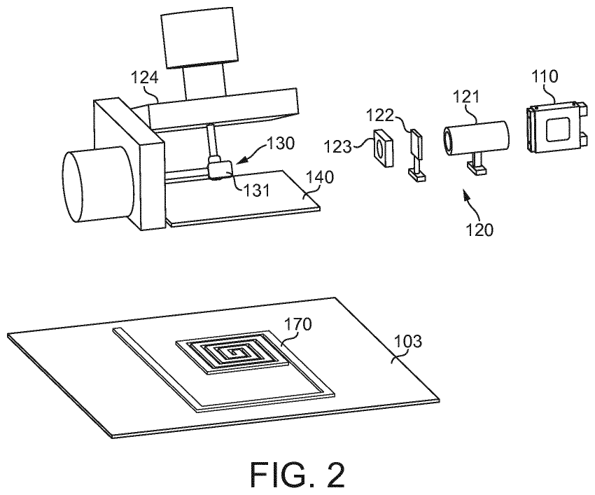

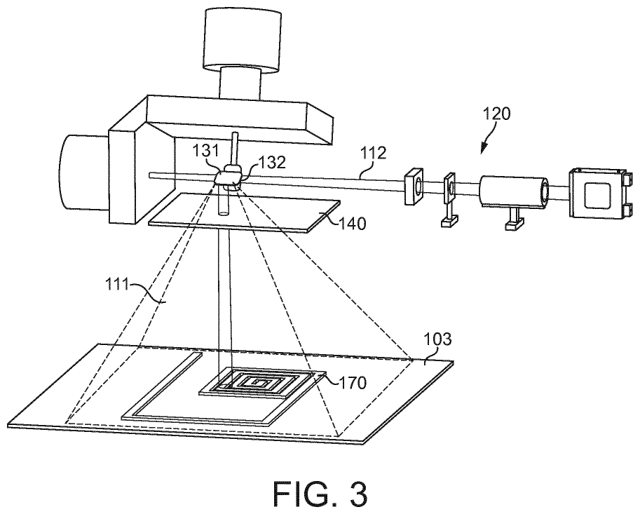

Another possible setup is to focus the laser beam on two mirrors which can rotate with a limited angle but at a very high speed thanks to the specific design of the actuators. The combination of the mirror rotation makes the beam move in any direction and can achieve a linear or a rotational displacement. The part of the device or feature integrating the two mirrors is usually known as high speed mirror galvanometer, as it is shown in FIGS. 2 and 3.

FIG. 2 shows a configuration of the cooking means in food processing system 100 as shown in FIG. 1. The cooking means comprises a laser setup comprising a laser source 110 and an optical system 120. The optical system 120 comprises a light collimator and/or a beam expander 121 to focus the laser beam emitted by the laser source 110. It further comprises a focal lens 122 and a laser beam aperture 123: the focal lens 122 is displaceable to be closer or farer from the laser source to focus in different ways the laser beam and the aperture 123 is able to shape the laser beam before it is sent to a steering system 130.

Once the laser beam has been created by the laser source 110, and it has been collimated and/or homogenized and/or focalized by the optical system 120, it is directed to a steering system 130 where it will be directed towards the deposition surface 103 where a food pattern 170 has been dispensed so as to heat/cook precisely at least a part of it. As earlier described, the system is configured according to the invention so as to heat/cook layer by layer of the deposited food pattern 170.

The steering system 130 comprises at least one mirror 131 or two mirrors 131, 132 and a galvanometer 124. The galvanometer 124 is used to move the mirrors 131, 132 in the steering system 130 at a certain speed, by means of an actuator. The faster the mirrors are moved, the smoother and more defined the projected beam will be. The galvanometer 124 is preferably a high speed galvanometer.

On the setup of the invention, as represented in FIGS. 2 and 3, the laser source 110, the optical system 120 and the steering system 130 are located far away from the working area (deposition surface 103): this will have a high impact on the size and bulkiness of the whole system. The laser beam galvanometer 124 needs to be also located in a separate cabinet or area in order to avoid smoke or condensation (fat, grease, etc.) which can deposit on the mirror actuator and on the mirrors themselves. If the mirror is contaminated, the laser beam can be completely absorbed by the mirror leading to a permanent mirror damage. Besides, the mirrors are coated with specific materials to reflect the specific wavelength of the laser source. If the coating is sublimed or vaporized in case of mirror contamination, the vaporized material may contaminate the prepared food which might injure human by absorption or by inhalation: this therefore requires an additional security feature such as a quartz window 140 to separate the food cabinet from the galvanometer, leaving at the same time the laser beam passing through it without producing light attenuation. The galvanometer may also require to be cooled down depending on the cooking process time and the power level. Finally, smoke exhaust can also be implemented with carbon filters in the galvanometer cabinet and in the food cabinet.

Therefore, in the food processing system of the invention, the laser source, the optical system and the steering system are typically located in separated and distinct chambers within the system.

FIG. 3 shows the production of a laser beam 112 and also how this one is diverted by the steering system 130 forming a scanning area 111 under which the food pattern 170 in the deposition area 103 will be cooked or heated by action of the laser beam directed to it.

In the system of the invention, the scanning area 111 in the deposition surface 103 is defined by the rotation of the mirrors 131, 132, their respective angle and their distance to the deposition surface 103.

The laser beam spot is focalized on the scanning mirror but when the mirror deviates the laser beam with an angle, the laser power density and the target surface energy decrease proportionally to this angle. Indeed, the geometry of the spot is directly dependent on the deviation angle making the spot size increase. The minimum spot size is achieved when the laser beam is perpendicular to the targeted surface area.

In the system of the invention, the laser power and/or wavelength and/or driving mode (continuous or pulsed) and/or scanning velocity is adapted to the nature of the food pattern deposited: besides, this is measured at different instant times along the heating and/or cooking process. Furthermore, the driving mode (continuous or pulsed) of the laser beam can also change as a function of the evolution of the food heated and/or cooked: typically, when the system operates emitting a pulsed laser beam, this penetrates in depth in the food pattern deposited to heat and/or cook it, such that the frequency and the length of the pulse defines the penetration rate in the food pattern deposited.

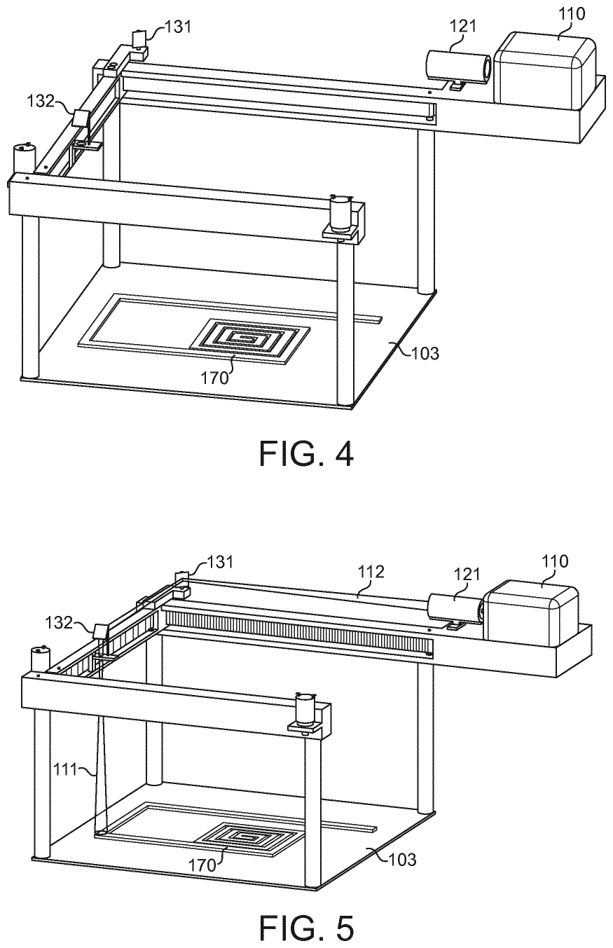

Looking now at FIGS. 4 and 5, a laser configuration setup with one laser source 110 is represented. The laser beam 112 created is directed to a first mirror 131 from where it is directed to a second mirror 132 and then directed onto the dispensing area 103, to a certain part of the food pattern 170 on it.

The dispensing area 103 can be made moveable with respect to the laser system, optical system 120 and steering system 130. This allows directing the laser beam towards the food pattern or the part of it that needs to be heated and/or cooked. Preferably, the laser beam is kept orthogonal to the dispensing area 103.

In the configuration shown in FIG. 4 or 5, the laser source 110 of the diode type is fixed along the X axis. The two reflective mirrors 131, 132 are fixed on the Y axis and typically only one of them (in the Figures attached, the mirror 132) is displaceable on the Y direction. Thus the laser beam generated is deviated toward the food pattern via the two mirrors and remains perpendicular to the food surface (deposition area 103). The advantage of such setup is that the light energy remains constant on the overall food surface. The laser spot size is dictated by the distance between the Y mirror and the food surface.

However, in such configuration, the laser source diode has to generate a very concentrated laser spot size; this is the reason why these laser sources are generally designed to be connected to an optical fibre with an integrated optical system.

The laser spot size and therefore the heat surface energy is limited by the size of the mirrors and the beam expander.

In order to allow the switching between two different laser wavelengths, it would be required to implement double number and setup of mirrors and the rest of the components of the system, in order to have one setup dedicated per each wavelength. This configuration allows more versatility but requires a deposition area and an overall size of the machine larger than in a standard configuration.

A high scanning velocity is desired in order to reduce cooking time and provide a better homogeneity of the cooked food texture, further avoiding the burning of the food surface and in order to obtain a better homogenization of the thermal energy in the food fraction.

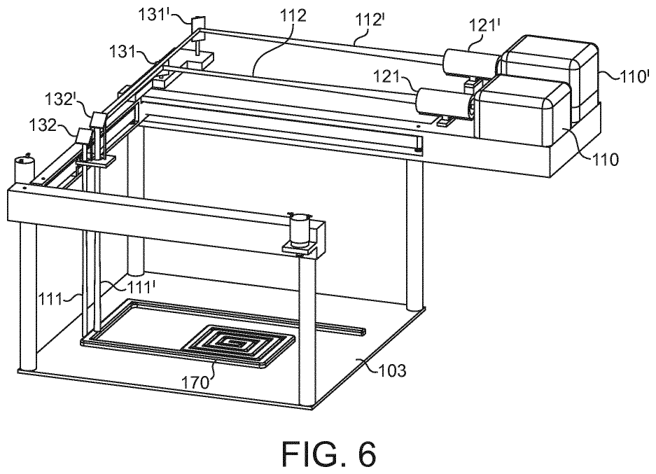

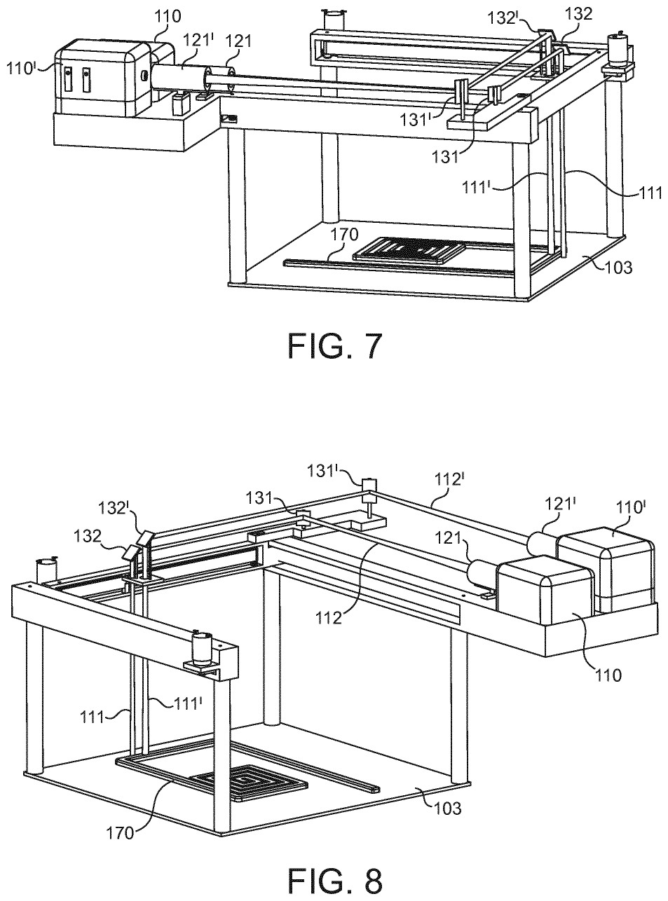

The configuration shown in FIGS. 6-7-8 shows cooking means comprising two laser sources 110, 110′, both of the diode type. Each laser source emits a laser beam 112, 112′ which is then directed to mirrors 131, 132 and 131′, 132′, and is then directed as laser beams 111 and 111′ directly onto the food pattern 170 deposited on the deposition area 103. Laser beams of the same or of different wavelengths can be emitted by each of the laser sources; on top, this kind of configuration allows two laser beams cooking the food pattern 170 consecutively or at the same time, which provides a higher versatility and also reduces the total cooking time.

According to a second aspect, the invention also relates to a method for preparing a foodstuff by using a food processing system 100 as the one described. The method comprises the following steps:
depositing onto the deposition area 103 a certain food pattern 170 in one or a plurality of shapes and/or layers;
activating the laser simultaneously or successively to the deposition of the food pattern to heat and/or cook at least part of the deposited shapes and/or layers.

In the method of the invention, the laser power and/or wavelength and/or driving mode (continuous or pulsed) and/or scanning velocity is adapted to the nature of the food pattern deposited, this being measured at different instant times along the heating and/or cooking process in order to provide a proper and optimum cooking.

Typically, a pulsed laser beam is used to heat and/or cook the food pattern 170 deposited, such that the frequency and the length of the pulse used are chosen according to the desired penetration rate in the food pattern deposited. This way, the configuration of the invention allows a proper adaptability of the process in order to provide the optimum cooking, and cooking features, for each layer or part of the food pattern deposited.

When using the pulsed mode of the laser beam, the aim is to penetrate and go deeper into the food product thickness. The combination of the wavelength of the laser beam and the pulsed mode targets the right cooking depth desired, as a function of the food properties and the food color.

When using high wavelength values of the laser beam, typically higher than 1000 nm, in continuous mode, the intention is to provide the finishing or browning of the food layer deposited. Therefore, depending on the operation (or driving) mode of the laser source, together with the wavelength value, chosen as a function of the type of food and its color, different cooking or heating effects will be provided as desired (deeper cooking, crispiness or browning of the surface, etc.).

Although the present invention has been described with reference to preferred embodiments thereof, many modifications and alternations may be made by a person having ordinary skill in the art without departing from the scope of this invention which is defined by the appended claims.

1. Food processing system able to deposit and/or deliver food under a certain pattern and to heat and/or cook at least part of it, wherein deposition is done onto a deposition surface by at least a deposition head in one or a plurality of shapes and/or layers;
the food processing system further comprises a cooker, the cooker comprising:
at least a laser source of the diode type generating at least a laser beam with a certain power and wavelength;
an optical system designed to collimate and/or focalize and/or homogenize the laser beam;
a steering system directing the laser beam from the optical system towards the food pattern deposited onto the surface, the steering system being able to cover a certain scanning area; and
the laser beam is directed to at least part of the food pattern as it is deposited onto the deposition surface or after it has been deposited so as to selectively heat and/or cook at least part of the deposited shapes and/or layers.

2. Food processing system according to claim 1 wherein the steering system comprises at least two rotatable mirrors, such that the scanning area in the deposition surface is defined by the rotation of the mirrors, their respective angle and their distance to the deposition surface.

3. Food processing system according to claim 1 wherein the steering system comprises a high speed mirror galvanometer set up.

4. Food processing system according to claim 2 wherein the mirrors are coated with a specific material to reflect the specific wavelength of the laser beam.

5. Food processing system according to claim 1 comprising at least one steering system with at least one laser source per laser beam wavelength provided.

6. Food processing system according to claim 1 wherein the deposition surface and the deposition head are moveable relative to each other in order to deposit a food pattern in one or a plurality of shapes and/or layers.

7. Food processing system according to claim 1 wherein the deposition surface and the cooker are moveable relative to each other in order to selectively heat and/or cook at least part of the deposited shapes and/or layers.

8. Food processing system according to claim 1 wherein the steering system is designed to direct the laser beam perpendicularly to the deposition area.

9. Food processing system according to claim 1 wherein the laser power and/or wavelength and/or driving mode and/or scanning velocity is adapted to the nature of the food pattern deposited, this being measured at different instant times along the heating and/or cooking process.

10. Food processing system according to claim 1 wherein the driving mode of the laser beam changes as a function of the evolution of the food heated and/or cooked.

11. Food processing system according to claim 1 wherein the optical system further comprises a light collimator and/or a beam expander.

12. Food processing system according to claim 1 wherein the optical system further comprises a focal lens displaceable to be closer or farer from the laser source.

13. Food processing system according to claim 1 wherein the optical system further comprises an aperture to shape the laser beam before it is sent to the steering system.

14. Food processing system according to claim 1 wherein the laser source, the optical system and the steering system are located in separated and distinct chambers within the system.

15. Food processing system according to claim 1 wherein the deposition surface is separated from the rest of the system by a window through which the laser beam penetrates, the window being made of a material adapted to the laser beam wavelength to provide maximum transmittance and minimum ab sorption.

16. Food processing system according to claim 1 wherein the laser source operates emitting a pulsed laser beam in order to penetrate in depth in the food pattern deposited to heat and/or cook it, such that the frequency and the length of the pulse defines the penetration rate in the food pattern deposited.

17. Method for preparing a foodstuff by using a food processing system that is able to deposit and/or deliver food under a certain pattern and to heat and/or cook at least part of it, wherein deposition is done onto a deposition surface by at least a deposition head in one or a plurality of shapes and/or layers, the food processing system further comprises a cooker, the cooker comprising at least a laser source of the diode type generating at least a laser beam with a certain power and wavelength, an optical system designed to collimate and/or focalize and/or homogenize the laser beam, a steering system directing the laser beam from the optical system towards the food pattern deposited onto the surface, the steering system being able to cover a certain scanning area, and the laser beam is directed to at least part of the food pattern as it is deposited onto the deposition surface or after it has been deposited so as to selectively heat and/or cook at least part of the deposited shapes and/or layers, the method comprising the following steps:
depositing onto the deposition area a certain food pattern in one or a plurality of shapes and/or layers; and
activating the laser simultaneously or successively to the deposition of the food pattern to heat and/or cook at least part of the deposited shapes and/or layers.

18. Method for preparing a foodstuff according to claim 17 wherein the laser power and/or wavelength and/or driving mode and/or scanning velocity is adapted to the nature of the food pattern deposited, this being measured at different instant times along the heating and/or cooking process.

19. Method for preparing a foodstuff according to claim 17 wherein a pulsed laser beam is used to heat and/or cook the food pattern deposited, such that the frequency and the length of the pulse used are chosen according to the desired penetration rate in the food pattern deposited.
